(19) United States
(12) Patent Application Publication
(10) Pub. No.: US 2020/0232604 A1
(43) Pub. Date: Jul. 23, 2020

(54) VALVE HAVING MEANS TO DETECT A CYLINDER IDENTITY UPON ATTACHMENT

(71) Applicant: Linde Aktiengesellschaft, München (DE)

(72) Inventors: Helmut FRANZ, Starnberg (DE); Kenth DROTT, Hohenschäftlarn (DE)

(21) Appl. No.: 16/650,444

(22) PCT Filed: Sep. 18, 2018
(86) PCT No.: PCT/EP2018/025238

§ 371 Date: Mar. 25, 2020

(30) Foreign Application Priority Data
Sep. 25, 2017 (GB) 1715459.2

(51) Int. Cl. F17C 13/04; F17C 13/02

(52) U.S. Cl. CPC F17C 13/04; F17C 13/025; F17C 2250/032; F17C 2223/0123; F17C 2221/011; F17C 2250/043; F17C 2205/0329; F17C 2205/0338

(57) ABSTRACT

The present invention pertains to a device for controlling a medical gas flow from a cylinder, wherein the device is configured to be releasably attachable to a gas cylinder and wherein the device is capable of identifying a gas cylinder in order to control the opening and closing of a valve comprised in the valve. Accordingly, the device comprises a valve for controlling a gas flow from a gas cylinder, a gas outlet, which is in fluid communication with said valve and positioned downstream of said valve, and a connecting means configured for receiving and releasably connecting a cylinder for providing a fluid connection between a cylinder and said valve. The device furthermore comprises an identifying means for identifying a cylinder, wherein the valve is in communication with the identifying means and is configured to be openable based on the identification of the cylinder.

### TECHNICAL FIELD

The invention relates to a device for gas cylinders, in particular gas cylinders comprising a medical gas, e.g. oxygen, for use in the medical field. In particular, the invention relates to a device for controlling a medical gas flow from a cylinder and which ensures a patient safety by preventing that a patient is treated with unsuitable medical gas.

### TECHNOLOGICAL BACKGROUND

In hospitals, it is known to supply medical gases by means of a centralized gas supply system to patients, wherein a centralized gas tank and/or a centralized cylinder set is connected to a pipeline system which is integrated in one or more buildings of the hospital. The pipeline system is connected to a plurality of wall outlets which are located on different wards of the hospital. The wall outlets are typically situated in all treatment rooms, surgical theaters as well as in many patient rooms. Thus, gas can be supplied by the centralized gas supply system from the central gas tank to the wall outlets via the pipelines. This enables provision of a medical gas directly to each ward, room and/or patient from the central gas tank. However, such a gas supply system may have the disadvantage that a patient may have limited mobility and e.g. may not be treated during transportation or relocation.

Accordingly, it is known to provide a mobile gas cylinder, for example equipped with a pressure regulator or with a medical VIPR (Valve integrated Pressure Regulator) and a nasal cannula or a face mask, an oxygen mask, or a mobile medical ventilator, to the patient, in particular during transport of the patient. Usually, the gas cylinder is arranged at a stand with wheels to provide portability. Patients need to be transported to/from or within the hospital for diagnose, for instance X-ray, MRI, endoscopy etc., treatment, surgery etc. or simply to leave the bed and move around, for example for visiting the bathroom or visiting facilities of the hospital where he can find other special medical treatment, like rehabilitation treatments. Furthermore, patients often prefer home care, wherein small mobile cylinders are commonly used in the provision of home oxygen therapy.

In order to provide a patient or medical professional with information relating to the performed treatment, the valve of such mobile gas cylinders often comprises additional electronic components, as e.g. known from US 2014/130875 A1. The complexity of the connected electronic and mechanical components in such valves, however, requires that such valves are integrated with the gas cylinder. Hence, such valves are not configured to be removed from a gas cylinder and comprise a fill port for refilling purposes, such that both the gas cylinder and the affixed valve would leave a medical facility to refill the respective gas cylinder. Since the cost of an intelligent cylinder or VIPR is much higher than the cost of a traditional analogue cylinder package, and considering that the overall cost is mainly in the valve, it leads to that generally only a limited number of intelligent valves associated with a corresponding gas cylinder is available in a medical facility and the non-availability of such an intelligent valve both increases the costs and limits the mobile patient treatment capability.

Additionally, since the valve is integrated with the cylinder, it means that also this more expensive part of the package needs to leave the facility and return to the filling station. This results in the fact that the productive time of the intelligent valve, which is the time when the intelligent valve is in the medical facility is greatly reduced, often to one third or less of the total time.

Accordingly, a need exists to increase the availability of intelligent valves in the medical facility during refilling of the respective gas cylinder. However, such intelligent valves are not compatible with regular gas cylinders. Furthermore, medical gases are applied for a large variety of diseases, such that, for a correct and safe application, it is required that the correct gaseous mixture or composition be present in the gas cylinder. Accordingly, the coupling of a valve with a regular gas cylinder without making such assessment prior to the application of the medical gas increases the risk of a mismatch between the medical gas contents in a gas cylinder and a patient treatment or dosage prescription and may hence provide a safety hazard to said patient. At present, intelligent valves do not measure a specific gas composition prior to a patient treatment but merely measure a gas pressure.

Therefore, a need exists to increase the availability of intelligent valves in the medical facility during refilling of the respective gas cylinder while reducing the costs and ensuring a patient safety for a mobile patient treatment.

### SUMMARY OF THE INVENTION

It is an object of the present invention to provide a device for controlling a medical gas flow from a cylinder, which may be combined with regular gas cylinders and which ensures a patient safety by identifying the composition of a gaseous mixture prior to the application of said gaseous mixture to a patient.

In a first aspect, a device for controlling a medical gas flow from a cylinder is suggested, which comprises a valve for controlling a gas flow from a gas cylinder, a gas outlet, the gas outlet being in fluid communication with said valve and positioned downstream of said valve, and a connecting means configured for receiving and releasably connecting a cylinder for providing a fluid connection between a cylinder and said valve. The device furthermore comprises an identifying means for identifying a cylinder, wherein the valve is in communication with the identifying means and is configured to be openable based on the identification of the cylinder.

The device may generally be compatible with pressurized gas cylinders and may comprise further features that are common in the art, such as e.g. a pressure regulator, a digital display to display a volume content and gas usage, and may be capable of calculating other different parameters such as remaining time and the amount of rest gas available in the gas cylinder. The required electronics may all be comprised in the device.

The releasable connecting means at least has the advantage that the device would be easily connected and disconnected to a gas cylinder, so that the gas cylinder could be disconnected when it is empty and a new, full cylinder could be connected to the same valve. This also allows that a smaller number of devices or VIPRs could be held in, for instance, a hospital ward and the gas cylinders would be exchanged when they were empty, such that only the respective gas cylinder would be sent away to be refilled and the device would stay in the ward and be used again with the next gas cylinder. Accordingly, the availability of the device is maintained, thereby also increasing the potential operation time of the device.

Furthermore, the identifying means ensures that a correct gas cylinder is coupled to the connecting means, such that e.g. the valve may only be opened, when a corresponding gaseous mixture is present that is suitable for delivery or application to a patient via the gas outlet and a patient interface. By the same token, the valve may remain closed, when the identified gas cylinder comprises a gaseous mixture that is not suitable for a required medical treatment.

The identifying means of the device may furthermore comprise an optical sensor or scanner and may be configured to read a coded information relating to a cylinder to be identified, wherein said coded information preferably is a barcode or OR-code. Accordingly, a gas cylinder to be identified may comprise a barcode at e.g. an end of a gas cylinder which is in proximity of the identifier upon coupling of the gas cylinder to the connecting means, such that the coded information may be read, thereby identifying the gas cylinder. For example, a scanner or barcode scanner may be connected to the device as a handheld device to enable a manual identification. However, such scanner is preferably integrated in the device, such that the device may require fewer components and does not rely on a manual input to identify a gas cylinder.

Alternatively or in addition, the identifying means may be configured as a wireless communication means and may be configured for establishing a wireless connection with an identifier entity of a cylinder to be identified, wherein said identifier entity comprises an information relating to a cylinder to be identified. The wireless communication means preferably comprises a Bluetooth device, a Zigbee device, and/or an RFID-reader for establishing a radio connection. Such wireless communications at least have the advantage that they allow easy implementation and may be configured to automatically establish a radio connection with the corresponding identifier entity on a gas cylinder, such that an identity of a cylinder may be automatically retrieved. This further reduces the amount of steps prior to the application of the medical gas and the start of a medical treatment, facilitates the coupling of the gas cylinder to the connecting means, and reduces the risk of inadvertently departing from a prescribed sequence of steps or protocol. In addition, the implementation of a corresponding identifier entity may allow the use of a higher complexity of the corresponding identity to comply with a larger variety of gaseous mixtures and/or to provide a unique identity of said gas cylinder.

Accordingly, the device may identify a gas cylinder merely by the provision of an information on a gas cylinder. The identification of a gas cylinder may e.g. trigger an electric or mechanical signal corresponding to the provided information to accordingly open or close the valve and hence control the valve of the device.

To further facilitate or evaluate the identification, for example, the device may comprise a reference information relating to at least one cylinder, wherein the valve is configured to be in a closed position, when an identified cylinder does not correspond to the reference information and wherein the valve is configured to be openable, when an identified cylinder corresponds to the reference information. Such reference information may e.g. be stored in the device, for example, in the identifying means, but may also be provided from an external source, such as a connectable storage medium, for example, a USB drive, a flash memory, a PDA or handheld device, and the like. Preferably, said reference information comprises information relating to the composition of a gas or gaseous mixture, a specific cylinder identifier, and/or a batch number. Accordingly, the identifying means may associate the identified container with a specific batch of gaseous mixtures or a specific gaseous mixture to ensure that an appropriate gaseous mixture is coupled to the device. Furthermore, the gas cylinder may be only compatible for a specific gaseous mixture, such that an identified cylinder may correspond to a specific cylinder identifier, thereby ensuring that a correct medical gas is present.

The connecting means may be configured to connect a connecting element at an end of a gas cylinder. Preferably, the connecting means is configured for receiving and engaging a geometric feature of a connecting element at an end of a cylinder, wherein said geometric feature preferably comprises at least one pin. For example, the arrangement of the geometric feature of at least one pin may correspond to the type of gas cylinder used and/or to the gaseous mixture present in a gas cylinder. Accordingly, the connecting element is preferably configured as a pin index valve. Hence, a number of pins may be used that are arranged in a distinct pattern on a connecting element of a gas cylinder, wherein the corresponding receiving end of the connecting element may be adapted to enclose and/or receive only a specific arrangement. This not only ensures that only a gas cylinder comprising a specific gaseous mixture is connected to the connecting means, but also makes the coupling of a gas cylinder fool proof, reducing the risk of inadvertent failures. The geometric feature may also comprise other shapes than a pin shape, for example, a rectangular or pyramid shape, and/or may be formed as a hook or detent which engages a corresponding catch or protrusion at the connecting means.

Furthermore, the connecting means may be in communication with the identifying means, wherein said identifying means is configured to automatically identify a cylinder, when the connecting means is engaged with a geometric feature of a connecting element at an end of a cylinder. This at least has the advantage that the identification of the gas cylinder occurs immediately after the coupling or attempt of coupling of the gas cylinder to the connecting means and may furthermore provide an identification of the gas cylinder on itself by its geometric compatibility. The automation furthermore reduces the amount of steps prior to the application of the medical gas and the start of a medical treatment and assists a medical professional during the coupling of the gas cylinder to the connecting means. In order to automatically identify a cylinder, the identifying means is preferably configured to be activated by a depression of a deformable protrusion on the connecting means, preferably a button or spring element, by a corresponding protrusion or detent on a cylinder or connecting element at an end of a cylinder, by a sensor, preferably by optical detection or depression of a pressure sensor or spring element, or by electrical stimulation, preferably by electrical elements or induction elements disposed on a cylinder or connecting element at an end of a cylinder. Accordingly, the identification may be triggered through activation of a corresponding electrical circuit.

Instead of matching with a specific geometric feature, the connecting means may also be arranged to receive and engage a plurality of geometric features, wherein said connecting means is configured to communicate an information relating to an arrangement of a plurality of geometric features of a connecting element to said identifying means. Accordingly, gas cylinders with different standards and/or gaseous mixtures may be coupled to the connecting means, wherein the connecting means may provide information about the arrangement of the various geometric features on a gas cylinder to the identifying means, e.g. by means of optical sensors, pressure sensors, or the like. For example, the plurality of geometric features may induce and/or transmit an electrical signal corresponding to a particular gas cylinder comprising a specific gaseous mixture.

Accordingly, the device may, alternatively, or in addition to an identification of a gas cylinder by an information on a gas cylinder, also identify a gas cylinder by means of a specific arrangement of at least one geometric feature.

For coupling of the device to a gas cylinder, the connecting means may be formed as a threaded coupling, a lever closure, or bayonet closure, wherein the connecting means is preferably formed as a single-turn or quick-release closure. To facilitate a coupling of a gas cylinder to the device, the device preferably comprises a motorized element, wherein the connecting means is in communication with the identifying means and is configured to automatically connect the valve to a gas cylinder or a connecting element at an end of a gas cylinder by means of the motorized element based on the identification of the cylinder. The connecting means may furthermore be configured to open a valve on a gas cylinder or a connecting element at an end of a cylinder based on the identification of the cylinder, for example, by means of a motorized element. This at least has the advantage that a user or medical professional is assisted in the coupling, such that the user is merely required to insert or mount a connecting element to the device, wherein the device is configured to automatically identify the gas cylinder and may connect the valve of the device to the corresponding end of the gas cylinder, when the identified gas cylinder is found to be compatible, and may open the valve and/or gas cylinder accordingly.

In order to increase the versatility and the mobility of the device, the device may be configured as a mobile device comprising a top part engaging a top end of a cylinder, a bottom part engaging a bottom end of a cylinder and a middle part between said top part and bottom part, wherein the device is preferably configured as a stand to stabilize a cylinder in a vertical orientation. The middle part is preferably slidably adjustable to accommodate a height of a cylinder. Accordingly, a variety of gas cylinder types having different gas volumes, dimensions and weight may be mounted to the device. The device may furthermore comprise fixation means, a plurality of rolls on a bottom end of the device, and/or at least one gripping portion, wherein said fixation means preferably comprises at least one strap, preferably a Velcro strap. Accordingly, the device may securely and/or releasably fix a gas cylinder to the device and vice versa. The fixation means may also be formed as at least one protrusion, e.g. at the bottom part of the device, such that a gas cylinder may be held by the device and is prevented from a sliding displacement or tilting. Furthermore, the gripping part may e.g. be formed as a handle or telescope handle for easy transportation purposes. However, the gripping part may also comprise other means such as e.g. a strap or band. Although a single roll may be provided, the device preferably comprises a plurality of rolls that may rotate around a vertical axis, thereby generally resembling a transportation system of trolleys, as known in the art. The device may also comprise fixation means that are formed to be attached to a carrying device of a patient, e.g. a backpack. Alternatively, the device may comprise a harness or may be formed as a backpack.

Although the device may be fully autonomous, the device may also be configured to communicate with or retrieve information from other entities. Accordingly, the device may comprise a communication means configured for establishing a connection with a database, wherein said communication means is preferably configured as a wireless communication means for establishing a wireless connection with a database. The database may comprise at least one reference information relating to at least one cylinder, wherein the communication means is configured to receive a reference information relating to at least one cylinder from said database. A database may be part of a database system or computer system, preferably a network or a LAN of a medical facility, but may also be provided in a wireless network environment. Accordingly, the communication means preferably comprises a Bluetooth device, a Zigbee device, Wi-Fi device, and/or an RFID-reader for establishing a radio connection with a database. Such wireless communications devices at least have the advantage that they allow easy implementation and may be configured to automatically establish a radio connection with a corresponding entity, such that, with appropriate authentication, information from an entity, e.g. a reference information relating to a cylinders identity, may be automatically retrieved. By the same token, a database may comprise patient and/or treatment information, such that the reference information may, alternatively, or in addition, relate to an allowable medical gas composition. Accordingly, an identified gas cylinder may not match with a corresponding reference information provided to the device, such that the valve is remained in a closed position. By the same token, should an identified container be compatible with a medical treatment, the valve may be opened.

Although a reference information may be provided in the device, e.g. by means of a storage medium, the identifying means is preferably in communication with or integrated in the communication means, wherein said communication means is in communication with said valve to control said valve. Integrating the identifying means in the communication means configured as a wireless communication means at least has the advantage that the device is compatible with an identifier entity of a cylinder to be identified, such that the identification requires no specific alignment and may occur automatically, when a gas cylinder is mounted to the device. Furthermore, the device may automatically retrieve a reference information via the communication means to be compared with the identified gas cylinder. Since the identifying means is integrated in the communication means, the communication means may hence be configured to control the valve directly, reducing the amount of steps to control the opening and closing of said valve.

Furthermore, the communication means may be configured to receive a patient information as a reference information, wherein the valve is configured to be in a closed position, when a received patient information does not correspond to an identified cylinder and wherein the valve is configured to be openable, when a received patient information corresponds to an identified cylinder. The communication means is preferably configured as a wireless communication means, wherein patient information may be received from a mobile patient entity transmitting said patient information. Accordingly, another layer of security is added in that the opening of the valve does not only depend on the identification of a gas cylinder and a reference information, but also requires said gas cylinder to be compatible with e.g. a patient, a disease status, and/or a medical treatment of the specific patient.

Preferably, a patient information comprises a prescribed treatment with a dosage regimen, wherein the communication means is configured to open the valve according to a received dosage regimen to output a corresponding gas flow to the gas outlet and a patient interface downstream of said gas outlet. To ensure that the output of medical gas to the gas outlet and a patient interface is correct, the device preferably comprises at least one flow sensor and the communication means preferably comprises a transmitting device, wherein said transmitting device transmits an information relating to the output of a gas flow to a database to update a patient information in a database. Accordingly, a dosage regimen may be continuously and/or periodically adjusted based on the current status of the patient and the patient treatment. The updated information and patient information may be provided and stored as data on a respective data storage solution.

To be able to adjust a flow volume per amount of time, the device may further comprise a pressure regulator integrated in said valve and being in fluid communication with said valve and said gas outlet, wherein the communication means is configured to adjust the pressure regulator in the valve according to a received dosage regimen to output a corresponding gas flow to the gas outlet and a patient interface downstream of said gas outlet. Accordingly, instead of providing a preset gas flow, the gas flow may be regulated depending on the required treatment by accordingly adjusting the pressure regulator.

The mobile patient entity may generally provide an identification of a patient and/or a compatible or required medical gas for a corresponding treatment. In order to provide a quick, safe and uncomplicated and in particular automatic reception of the patient identifier, the communication means is configured to establishing a wireless connection with a mobile identifier entity comprising the patient identifier, preferably via a radio connection, as described above. In particular a Bluetooth, Wi-Fi, RFID or a similar comparable data transfer and storage solution is preferred. The mobile patient entity is most preferably transmitted by a wearable device worn by the patient such as a wristband including an RFID chip or Bluetooth chip or any other data transmission and storage solution.

Accordingly, a patient to whom medical gas is to be supplied from the gas outlet from the device is merely required to be in vicinity of the device to establish a required wireless connection. The provision of at least one wearable mobile patient entity ensures that the mobile identifier entity is always located at the patient. Thus, unintentional interruption of medical gas supply due to a disconnection of the mobile patient entity and the device is avoided.

Furthermore, by implementation of a mobile patient entity and a transmitter, the medical gas consumption may be measured and updated in a database. Accordingly, the device may comprise a monitoring device to monitor said medical gas consumption. In particular, when the patient is supplied with medical gas or medical gases via different monitoring devices during his stay at the medical facility, for instance due to his treatment plan or in case of transfer of the patient, easy and reliable monitoring of the patient's gas consumption is enabled. Such monitoring device for monitoring medical gas consumption of a patient in a medical facility may be provided by e.g. a flow sensor provided in a valve or pressure regulator of the device. A monitoring device provides at least the advantage that monitoring gas consumption of the medical gas according to a certain consumer, i.e. a patient, is enabled. Thus, the amount of consumed gas is determinable per patient, thereby enabling a direct cost allocation and/or invoicing with regard to the actual gas consumption.

To further ensure the safety of the device, the device may comprise a signaling device and at least one of a pressure sensor or a flow sensor in communication with said signaling device, wherein said signaling device is configured to output an alarm signal, when the at least one pressure sensor or flow sensor exceeds a predetermined limit. For example, during treatment the valve may be in an opened position, however, the amount of gas in the gas cylinder may be below a certain volume, such that a continuation of a treatment may be impaired. By the same token, a defect in a valve or pressure regulator or a false dosage regimen may lead to an undesirable and even hazardous output flow. Accordingly, an alarm signal may be provided to indicate the occurrence of a problem with a current device, gas cylinder, and/or treatment.

The device may furthermore be comprised in a system for controlling a medical gas flow from a cylinder to a patient interface. Accordingly, such system at least comprises a device for controlling a medical gas flow from a cylinder, as described in the above, a gas cylinder, and a patient interface. In the system, the gas cylinder is connected to the valve by means of the connection means and the valve is in communication with the identifying means, wherein the valve is configured to be openable based on the identification of the cylinder to output a gas flow from the cylinder via the valve and gas outlet to the patient interface.

The device may comprise various features and may be configured to communicate with other entities, as described above. Preferably, a device in such system comprises a wireless communication means with an identifying means integrated therein, such that it is configured to identify an identifier entity on the gas cylinder. In addition, the communication means of the device may be configured to receive a reference information from a database or from a mobile patient entity. In addition, the communication means may be configured to provide an update information to a database according to a treatment being performed.

### BRIEF DESCRIPTION OF THE DRAWINGS

The present disclosure will be more readily appreciated by reference to the following detailed description when being considered in connection with the accompanying drawings in which:

FIG. 1 is a schematic view of a device for controlling a medical gas flow from a cylinder;

FIG. 2 is a schematic view of a device according to FIG. 1 having a communication means;

FIG. 3 is a schematic view of a device according to FIG. 2 showing further features of the connecting means and communication means;

FIG. 4 is a schematic view of a device according to FIG. 2 showing further features of the connecting means, communication means, and gas outlet;

FIG. 5 is a schematic view of a device according to FIG. 1 having a gas cylinder coupled to the device;

FIG. 6 is a schematic view of a device according to FIG. 4 having a gas cylinder coupled to the device, wherein the device is configured as a stand or clip;

FIG. 7 is a schematic view of a device according to FIG. 6 having a gas cylinder coupled to the device, wherein the identifying means is integrated in the communication means; and

FIG. 8 is a schematic view of a device for controlling a medical gas flow from a cylinder in a system.

### DETAILED DESCRIPTION OF PREFERRED EMBODIMENTS

In the following, the invention will be explained in more detail with reference to the accompanying figures. In the Figures, like elements are denoted by identical reference numerals and repeated description thereof may be omitted in order to avoid redundancies.

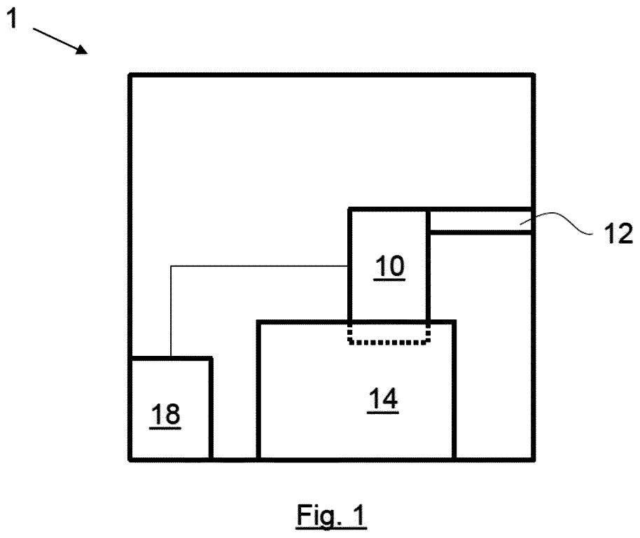

In FIG. 1 a device 1 for controlling a medical gas flow from a cylinder is shown, which comprises a valve 10 and a gas outlet 12 positioned downstream of the valve 10. The gas outlet 12 is in fluid communication with the valve, such that the valve, when in an opened position, may allow a gas to flow from a coupled container (not shown) via the valve 10 and the gas outlet 12 to a patient interface, e.g. a nasal mask or ventilator (not shown). The valve 10 is accordingly connected to a connecting means 14 for connecting a gas cylinder or a connecting element at an end of a gas cylinder (not shown) to the device 1, such that a fluid connection between a cylinder and the valve 10 is provided. The device 1 furthermore comprises an identifying means 18, which is connected with the valve 10 and is configured to identify a cylinder. The valve 10 is furthermore configured to be opened based on the identification of the container. Accordingly, the identifying means 18 may provide a trigger or input to the valve 10.

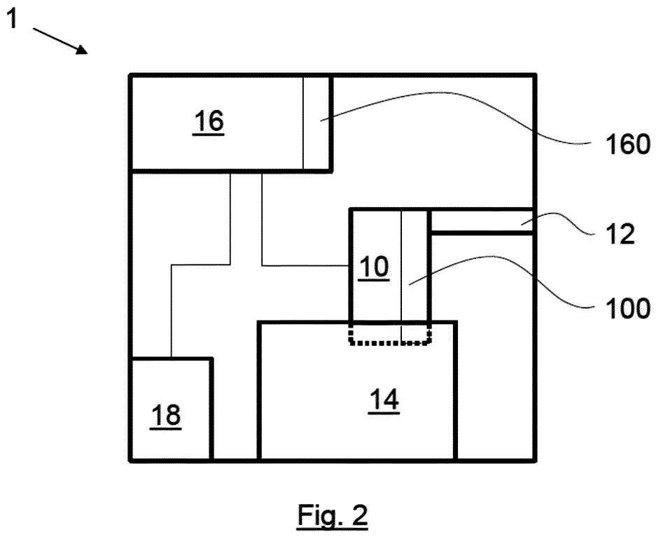

FIG. 2 shows the device 1 of FIG. 1, wherein the valve 10 of the device 1 comprises an adjustable pressure regulator 100. The device 1 furthermore comprises a communication means 16. The communication means 16 is in communication with the identifying means 18 and is furthermore connected with the valve 10 to accordingly control said valve 10 and the pressure regulator 100. As depicted in FIG. 2, the communication means 16 comprises a reference information 160. Alternatively, such reference information 160 may be provided by a storage medium in the device or may be provided by an external device or storage solution, such as e.g. a USB stick. The reference information 160 comprises information relating to a gas cylinder, e.g. a suitable composition of a gaseous mixture or a gas cylinder number that may be accepted by the device 1 for patient treatment. Accordingly, the identifying means 18 provides a corresponding information to the communication means 16, wherein the communication means 16 compares the information provided by the identifying means 18 with the reference information 160, such that the communication means 16 may accordingly open or close the valve 10 of the device 1. Although FIG. 2 shows that the identifying means 18 is in communication with the communication means 16 and is not in communication with the valve 10, the identifying means 18 may also be in communication with the valve 10, thereby replacing the control communication between the communication means 16 and the valve 10. Accordingly, the communication means 16 may provide the reference information 160 to the identifying means 18, wherein the identifying means may control the valve 10 as described for FIG. 1.

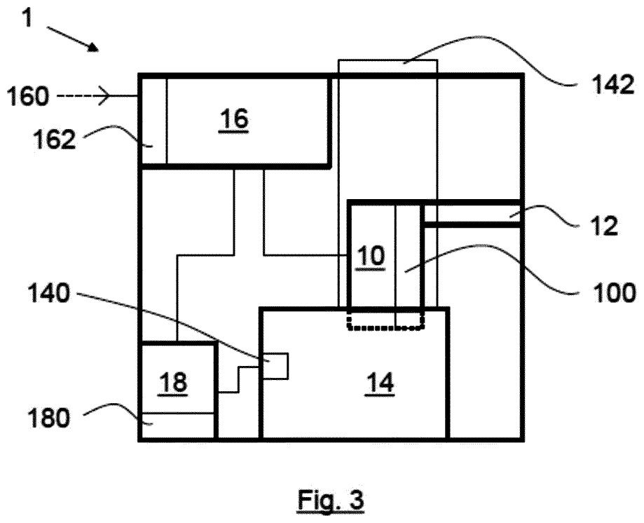

According to FIG. 3, the connecting means 14 comprises a single-turn closure 142 to connect the connecting means 14 with a connecting element of a gas cylinder and to provide a fluid communication between a connecting element of a gas cylinder and the valve 10 of the device 1. Accordingly, the single-turn closure 142 provides an easy handling for a user. The device 1 furthermore comprises a deformable protrusion or sensor 140, which is in communication with the identifying means 18. Accordingly, a sensor 140 may provide a signal to the identifying means 18 corresponding to a gas cylinder to be identified. For example, a geometric feature of a connecting element of a gas cylinder (not shown) may be detected by the sensor 140 or may engage or depress the sensor 140, such that the sensor 140 communicates a corresponding signal to the identifying means 18. Accordingly, the identifying means 18 receives a general information relating to the type of gas cylinder coupled to the device 1. In addition, the identifying means 18 comprises an optical sensor 180 e.g. formed as a barcode scanner to optically detect a coded information (not shown) comprised on a gas cylinder. Such coded information may be provided by a barcode and comprises further information relating to the contents in the gas cylinder, e.g. the gaseous mixture retained in the gas cylinder. This information is then communicated to the communication means 16, which is configured in FIG. 3 as a wireless communication means 162 and is configured to receive the reference information 160 via a radio connection with a database (not shown), as indicated by the dashed line. Accordingly, the communication means 16 compares the provided information received from the identifying means 18 with the reference information 160 to control the valve 10.

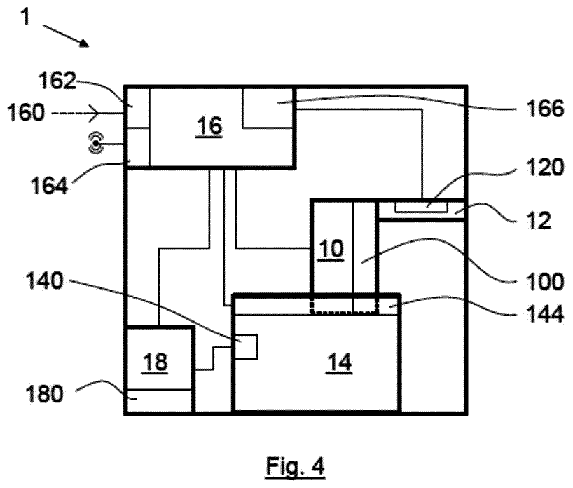

As an alternative to the single-turn closure 142 in FIG. 3, the device 1 may comprise a motorized element 144 to connect the valve 10 by means of the connecting means 14 to a corresponding connecting element of a gas cylinder, as schematically shown in FIG. 4. The motorized element 144 is in communication with the communication means 16, such that the connection between the device 1 and a gas cylinder may be automatically established by the motorized element 144, when a corresponding output is provided by the communication means 16. Upon detection of a geometric feature of a connecting element of a gas cylinder by a sensor 140, which corresponds to a suitable gas cylinder, the communication means 16 automatically outputs a signal to the motorized element 144 to connect the gas cylinder. Accordingly, a user is immediately provided with feedback, whether the inserted gas cylinder is suitable for a patient treatment or device or not. The motorized element 144 may also assist in coupling the device 1 to a gas cylinder, wherein e.g. a single-turn closure 142 may be closed or connected by means of the motorized element 144 and/or wherein a single-turn closure 142 may initiate the connection between the device 1 and a gas cylinder.

In addition, the device 1 in FIG. 4 comprises both a flow sensor 120 and a signaling means 166, which are in communication with each other. The signaling device 166 is configured to detect a flow from the flow sensor 120, which is provided in the gas outlet 12, and provides an alarm signal, when a predetermined limit is exceeded. For example, in case of a leaking valve or false setting, the signaling device 166 may indicate an alarm signal relating to an overpressure, such that a user or patient is informed and a health risk is reduced. The signaling device 166 is provided in the communication means 16. Accordingly, the device 1 may comprise either stored limits or may be provided by such limits via a reference information 160 via the wireless communication means 162. As an alternative to the flow sensor, the gas outlet 12 may comprise a pressure sensor 120, having the same communication function, such that a signaling device 166 may e.g. indicate that a required pressure for a treatment is not present. The communication means 16 is furthermore provided with a transmitting device 164, such that the device 1 is capable of communicating a signal or information to other entities, e.g. to accordingly update a status field in a database.

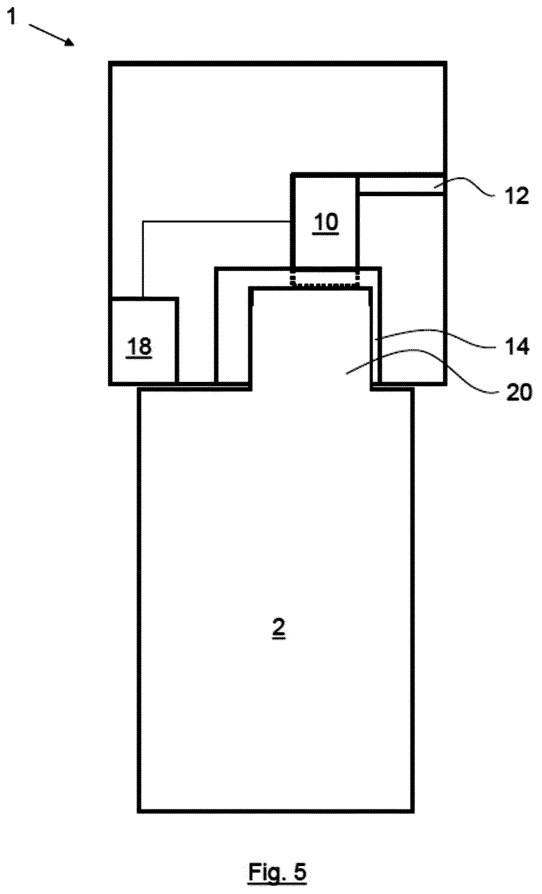

FIG. 5 shows the features of the device 1 according to FIG. 1, wherein a gas cylinder 2 is coupled to the device 1. Accordingly, a connecting element 20 of the gas cylinder 2 is connected to the valve 10 by means of the connecting means 14. In the coupled and connected combination of the device 1 and the gas cylinder 2 the identifying means 18 may identify the gas cylinder 2 and accordingly control the opening and closing of the valve 10 to provide a gas flow from the gas cylinder 2 via the valve 10 to the gas outlet 12 and e.g. a connected patient interface (not shown). Both the device 1 and the gas cylinder 2 are schematically depicted with only few features, however, it will be obvious for a person skilled in the art that such combination may comprise a plurality of features, as described in the above and as shown in the embodiments.

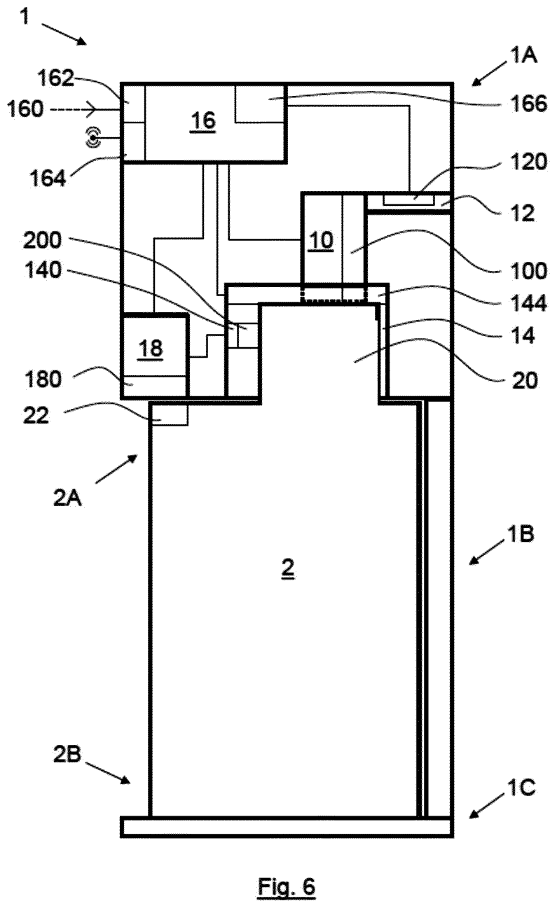

For example, a device 1 and a coupled gas cylinder 2 are schematically depicted in more complexity in FIG. 6, wherein a gas cylinder 2 is coupled to the device 1. The device 1 resembles the device 1 as shown in FIG. 4 and is configured as a stand or clip comprising a top part 1A, a bottom part 1B and a middle part 1C. The middle part may be slidably adjustable to accommodate a variety of gas cylinder heights. The majority of the features of device 1 are arranged in the top part 1A of the device 1, whereas the bottom part 1B may provide stability for the gas cylinder 2 or may be formed as a clip element, to releasably engage the bottom part 1B. The gas cylinder 2 comprises a geometric feature 200 at the connecting element 20 at a top end 2A of the gas cylinder 2. The geometric feature 200 is detected by a deformable protrusion 140, which is depicted to be deformed or depressed by the geometric feature 200 upon coupling or insertion of the gas cylinder 2 to the device 1. The deformation or depression of the deformable protrusion 140 corresponds to the insertion of a specific or suitable gas cylinder 2, such that a signal is communicated to the identifying means 18 and the communication means 16 automatically outputs a signal to the motorized element 144 to connect the gas cylinder 2.

In addition to the geometric feature 200, the gas cylinder 2 is identified by a scanner 180 of the identifying means 18. The gas cylinder 2 as depicted in FIG. 6 comprises a coded information 22, e.g. a barcode, at a top end 2A of the gas cylinder 2, which is brought into proximity of the scanner 180 upon insertion and coupling. Although the coded information is depicted on one side of the gas cylinder 2, the coded information 22 may also be provided at a plurality of points at the top end 2A of the gas cylinder 2 or may be provided continuously in a circular manner on the top end 2A to facilitate alignment of the gas cylinder 2 for scanning and identifying purposes. After insertion of the gas cylinder 2, the coded information 22 may then be scanned and a corresponding signal or information may be communicated to the communication means 16 to be compared with a reference information 160 in order to control the valve 10.

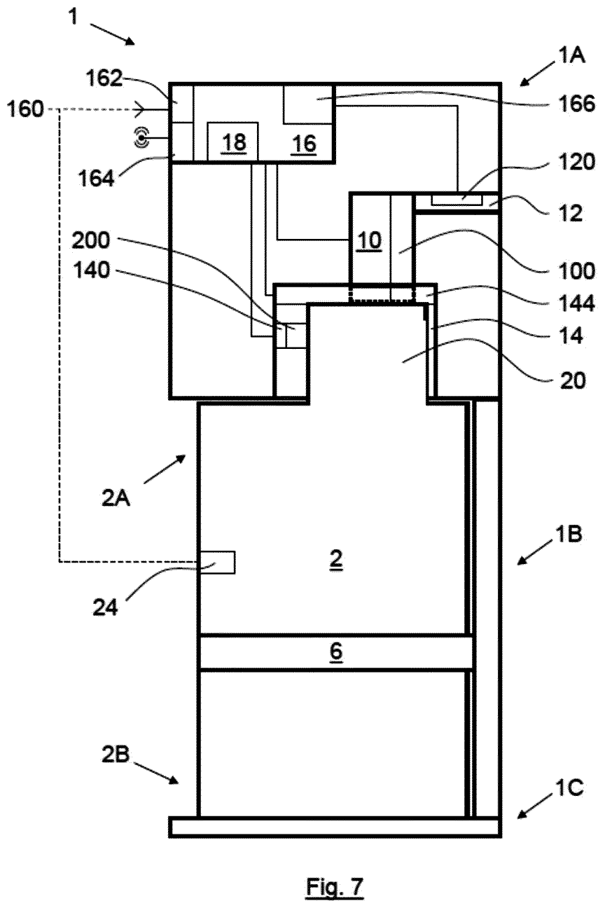

The combination of the device 1 and the gas cylinder 2 as schematically depicted in FIG. 7 generally resembles the features shown in FIG. 6. Instead of comprising a scannable coded information 22 on the gas cylinder 2, the gas cylinder 2 comprises a identifier entity 24. The identifier entity 24 may comprise or correspond to the same information as a coded information 22 or may comprise more complex data structures. The identifying means 18 is accordingly integrated in the communication means 16, which is configured as a wireless communication means 162 comprising a wireless receiving element. The identifying means 18 may hence wirelessly retrieve and receive the information provided by the identifier entity 24 to identify the gas cylinder 2, as indicated by the dashed line. Accordingly, the number of devices may be reduced and a proper alignment of the gas cylinder 2 with the device 1 is not required to identify said gas cylinder 2. The integration of the identifying means 18 in the communication means 16 allows the coupling and identification of the gas cylinder 2 to the device 1 as well as the opening and closing of the valve 10 to occur in a fully automated manner, such that a user or medical professional is facilitated during the setup of a medical treatment for a patient.

The device 1 and gas cylinder 2 may also be configured to be fully mobile, such that a patient has a larger range of motion and may be treated at different locations without any significant treatment interruptions. To facilitate the transportation of a mobile combination, the device 1 may comprise a fixation means 6 to securely fix the gas cylinder 2 to the device 1. This may also be required in medical facilities to prevent a combination to tilt and fall down. Accordingly, other fixation means may be provided, e.g. to securely attach the gas cylinder to a wall or the like. Furthermore, fixation means may be provided to attach the device 1 to a carrying or transportation device of a patient, e.g. a backpack.

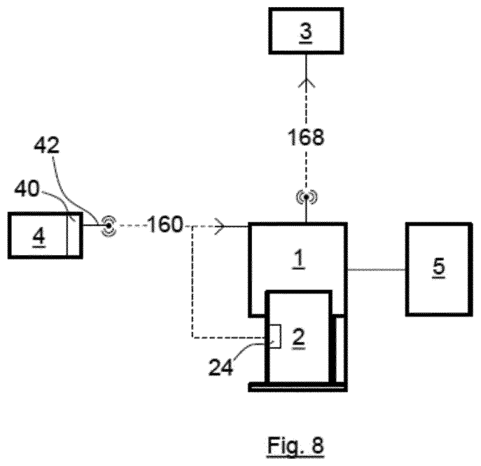

FIG. 8 schematically shows a device 1 for controlling a medical gas flow from a gas cylinder 2 in a system. For reasons of redundancy, the various features of the device 1 are not shown. However, it will be obvious to a person skilled in the art that the device 1 and gas cylinder 2 may comprise a plurality of features, as described in the above. According to the system shown in FIG. 8, the device 1 at least comprises a wireless communication means to receive a reference information 160. The reference information 160 is emitted by a transmitter 42 from a mobile patient entity 4 comprising a patient information 40. Accordingly, the patient information 40 may be used as a reference information 160 for comparison with the identified gas cylinder 2. The gas cylinder 2 is identified by the wireless communication means by means of an identifier entity 24. Accordingly, the device 1 may control the valve by comparing the reference information 160 with the information retrieved from the identifier entity. Should the gas cylinder 2 be found to be compatible with the reference information 160, i.e. to be suitable for a patient treatment, the device 1 may open the valve of the device and output a gas flow from the container via the valve and the gas outlet to a patient interface 5, e.g. a nasal mask or a ventilator. The device 1 may furthermore be in communication with a database 3 or computer system comprising a database 3, such that the device 1 may communicate an updating information 168 relating to e.g. a current treatment status of a patient to the database 3. In addition, the system may comprise a monitoring system (not shown), such that the updating information 168 may also be used for e.g. medical billing purposes.

It will be obvious for a person skilled in the art that these embodiments and items only depict examples of a plurality of possibilities. Hence, the embodiments shown here should not be understood to form a limitation of these features and configurations. Any possible combination and configuration of the described features can be chosen according to the scope of the invention.

### LIST OF REFERENCE NUMERALS

1 Device for controlling a medical gas flow from a cylinder
1A top part
1B bottom part
1C middle part
10 valve
100 pressure regulator
12 gas outlet
120 flow sensor or pressure sensor
14 connecting means
140 deformable protrusion or sensor
142 single-turn closure
144 motorized element
16 communication means
160 reference information
162 wireless communication means
164 transmitting device
166 signaling device
168 updating information
18 identifying means
180 optical sensor or scanner
2 gas cylinder
2A top end
2B bottom end
20 connecting element
200 geometric feature
22 coded information
24 identifier entity
3 database
4 mobile patient entity
40 patient information
42 transmitter
5 patient interface
6 fixation means

1. Device (1) for controlling a medical gas flow from a cylinder (2), comprising:
a valve (10) for controlling a gas flow from a gas cylinder (2);
a gas outlet (12), the gas outlet (12) being in fluid communication with said valve (10) and positioned downstream of said valve (10); and
a connecting means (14) configured for receiving and releasably connecting a cylinder (2) for providing a fluid connection between a cylinder (2) and said valve (10),
characterized in that
the device (1) comprises an identifying means (18) for identifying a cylinder (2), wherein the valve (10) is in communication with the identifying means (18) and is configured to be openable based on the identification of the cylinder (2).

2. Device (1) according to claim 1, characterized in that the identifying means (18) comprises an optical sensor or scanner (180) and is configured to read a coded information (22) relating to a cylinder (2) to be identified, said coded information (22) preferably being a barcode or QR-code, and/or wherein the identifying means (18) is configured as a wireless communication means and is configured for establishing a wireless connection with an identifier entity (24) of a cylinder (2) to be identified, said identifier entity (24) comprising an information relating to a cylinder (22) to be identified, wherein said wireless communication means preferably comprises a Bluetooth device, a Zigbee device, and/or an RFID-reader for establishing a radio connection.

3. Device (1) according to claim 1, characterized in that the device (1) comprises a reference information (160) relating to at least one cylinder (2), wherein the valve (10) is configured to be in a closed position, when an identified cylinder (2) does not correspond to the reference information (160) and wherein the valve (10) is configured to be openable, when an identified cylinder (2) corresponds to the reference information (160), said reference information (160) preferably comprising information relating to the composition of a gas or gaseous mixture, a specific cylinder identifier, and/or a batch number.

4. Device (1) according to claim 1, characterized in that the connecting means (14) is configured for receiving and engaging a geometric feature (200) of a connecting element (20) at an end of a cylinder (2), said geometric feature (200) preferably comprising at least one pin, wherein the connecting element (20) is preferably configured as a pin index valve.

5. Device (1) according to claim 4, characterized in that the connecting means (14) is in communication with the identifying means (18), said identifying means (18) being configured to automatically identify a cylinder (2), when the connecting means (14) is engaged with a geometric feature (200) of a connecting element (20) at an end of a cylinder (2), wherein the identifying means (18) is preferably configured to be activated by a depression of a deformable protrusion (140) on the connecting means (14), preferably a button or spring element, by a corresponding protrusion or detent on a cylinder (2) or connecting element (20) at an end of a cylinder (2), by a sensor (140), preferably by optical detection or by depression of a pressure sensor or spring element, or by electrical stimulation, preferably by electrical elements or induction elements disposed on a cylinder (2) or connecting element (20) at an end of a cylinder (2).

6. Device (1) according to claim 4, characterized in that the connecting means (14) is arranged to receive and engage a plurality of geometric features (200), said connecting means (14) being configured to communicate an information relating to an arrangement of a plurality of geometric features (200) of a connecting element (20) to said identifying means (18).

7. Device (1) according to claim 1, characterized in that the connecting means (14) is formed as a threaded coupling, a lever closure, or bayonet closure, wherein the connecting means (14) is preferably formed as a single-turn or quick-release closure (142), the device (1) preferably comprising a motorized element (144), wherein the connecting means (14) is in communication with the identifying means (18) and is configured to automatically connect the valve (10) to a cylinder (2) by means of the motorized element (144) based on the identification of the cylinder (2), said connecting means (14) preferably being furthermore configured to open a valve on a cylinder (10) based on the identification of the cylinder (2).

8. Device (1) according to claim 1, characterized in that the device (1) is configured as a mobile device (1) comprising a top part (1A) engaging a top end (2A) of a cylinder (2), a bottom part (1B) engaging a bottom end (2B) of a cylinder (2) and a middle part (1C) between said top part (1A) and bottom part (1B), the device (1) preferably being configured as a stand to stabilize a cylinder (2) in a vertical orientation, said middle part (1C) preferably being slidably adjustable to accommodate a height of a cylinder (2), the device (1) preferably comprising fixation means (6), a plurality of rolls on a bottom end of the device (1), and/or at least one gripping portion, said fixation means (6) preferably comprising at least one strap, preferably a Velcro strap.

9. Device (1) according to claim 1, characterized in that the device (1) comprises a communication means (16) configured for establishing a connection with a database (3), said communication means (16) preferably being configured as a wireless communication means (162) for establishing a wireless connection with a database (3), said database (3) comprising at least one reference information (160) relating to at least one cylinder (2), wherein the communication means (16) is configured to receive a reference information (160) relating to at least one cylinder (2) from said database (3), said communication means (160) preferably comprising a Bluetooth device, a Zigbee device, Wi-Fi device, and/or an RFID-reader for establishing a radio connection with a database (3).

10. Device (1) according to claim 9, characterized in that the identifying means (18) is in communication with or integrated in the communication means (16), wherein said communication means (16) is in communication with said valve (10) to control said valve (10).

11. Device (1) according to claim 9, characterized in that the communication means (16) is configured to receive a patient information (40) as a reference information (160), wherein the valve (10) is configured to be in a closed position, when a received patient information (40) does not correspond to an identified cylinder (2) and wherein the valve (10) is configured to be openable, when a received patient information (40) corresponds to an identified cylinder (2), said communication means (16) preferably being configured as a wireless communication means (162), wherein a patient information (40) may be received from a mobile patient entity (4) transmitting said patient information (40).

12. Device (1) according to claim 11, characterized in that a patient information (40) comprises a prescribed treatment with a dosage regimen, wherein the communication means (16) is configured to open the valve (10) according to a received dosage regimen to output a corresponding gas flow to the gas outlet (12) and a patient interface (5) downstream of said gas outlet (12), the device (1) preferably comprising at least one flow sensor (120) and the communication means (16) preferably comprising a transmitting device (164), wherein said transmitting device (164) transmits an information relating to the output of a gas flow to a database (3) to update a patient information in a database (3).

13. Device (1) according to claim 12, characterized in that the device (1) comprises a pressure regulator (100) integrated in said valve (10) and being in fluid communication with said valve (10) and said gas outlet (12), said communication means (16) being configured to adjust the pressure regulator (100) in the valve (10) according to a received dosage regimen to output a corresponding gas flow to the gas outlet (12) and a patient interface (5) downstream of said gas outlet (12).

14. Device (1) according to claim 1, characterized in that the device (1) comprises a signaling device (166) and at least one of a pressure sensor or a flow sensor (120) in communication with said signaling device (166), said signaling device (166) being configured to output an alarm signal, when the at least one pressure sensor or flow sensor (120) exceeds a predetermined limit.

15. System for controlling a medical gas flow from a cylinder (2) to a patient interface (5), the system comprising:
a device (1) for controlling a medical gas flow from a cylinder (2) according to claim 1;
a gas cylinder (2); and
a patient interface (5),
wherein the gas cylinder (2) is connected to the valve (10) by means of the connection means (14) and wherein the valve (10) is in communication with the identifying means (18) and is configured to be openable based on the identification of the cylinder (2) to output a gas flow from the cylinder (2) via the valve (10) and gas outlet (12) to the patient interface (5).
